(19) United States
(12) Patent Application Publication
(10) Pub. No.: US 2005/0034438 A1
(43) Pub. Date: Feb. 17, 2005

(54) Towable rotary mowing apparatus

(76) Inventors: Steven A. Burke, Champlin, MN (US); Douglas A. Neudecker, Prior Lake, MN (US); Roger A. Kisch, West St. Paul, MN (US); Robert S. Kinkead III, St. Paul, MN (US); Joel F. Orthmann, Knoxville, TN (US)

Correspondence Address: NIKOLAI & MERSEREAU, P.A., 900 SECOND AVENUE SOUTH, SUITE 820, MINNEAPOLIS, MN, 55402, US

(21) Appl. No.: 10/777,024

(22) Filed: Feb. 11, 2004

Related U.S. Application Data
(60) Provisional application No. 60/447,108, filed on Feb. 12, 2003.

(51) Int. Cl. A01D 75/30

(52) U.S. Cl. 56/6

(57) ABSTRACT

A towable rotary mowing apparatus (10) includes a tow frame (30) for ganging together a plurality of rotary mowers (12) which are allowed to rotate about three axes (pitch, roll, yaw). The tow frame (30) includes a mid link (60) having opposite ends pivotally connected about side axes between first and second mowers (12) and having a carrier (66) for common components of the mowers (12). The third mower (12) is pivotally connected to a rear link (74) about a rear axis and which in turn is pivotally connected to the mid link (60) about the three axes. The control circuit of a control box (70) starts and stops operation of the mowers (12) by actuation of a handheld remote control device (120). A first timer (106) actuates a starter solenoid (108) for actuating the starters (100) and a second timer (110) actuates a choke actuator (112) of the engines (16) of the mowers (12).

### CROSS REFERENCE

This application is a continuation-in-part of U.S. Appln. No. 60/447,108 filed on Feb. 12, 2003.

### BACKGROUND

The present invention generally relates to mowing apparatus, particularly to a plurality of mowing apparatus towable in a gang arrangement, and specifically to towable rotary mowers in a gang arrangement.

To maximize efficiency, it is desirable that wide swathes be mowed. Due to variations in terrain, it is advantageous that individual mowers be ganged together rather than utilize a single large mower. Ganging individual mowers has often occurred utilizing reel-type lawn mowers. However, ganging rotary mowers has generally not achieved market success, as it is believed that the inherent structural and operational features of rotary mowers do not lend themselves to be ganged together. When ganged together, rotary mowers are often ganged behind a riding rotary lawn mower and not behind a towing vehicle which does not perform a mowing function.

Thus, a need exists for a novel towable mowing apparatus including a plurality of mowers which are ganged together and pivotably connected by a tow frame by multiple axes of rotation, and which in the most preferred form utilizes rotary mowers. Further, a need exists for control circuits which can start or stop operation of the plurality of mowers from a location remote from the plurality of mowers. Furthermore, a need exists for control circuits for remotely starting internal combustion engines by actuating electrical starters for a limited time by a timer, with such control circuits being especially advantageous when utilizing ganged mowing apparatus.

### SUMMARY

The present invention solves these needs and other problems and deficiencies in the field of mowing apparatus by providing, in the preferred form, first and second mowers pivotally connected to a towing tongue of a tow frame about a front axis, with the front axis being perpendicular to the towing direction. The first mower is pivotably connected to the towing tongue about a first side axis parallel to and spaced from the towing direction, and the second mower is pivotably connected to the towing tongue about a second side axis parallel to and spaced from the towing direction and to the first side axis. A third mower is pivotably connected relative to the first and second mowers about a mid axis, a swivel axis perpendicular to the mid axis, and a pivot axis perpendicular to the mid axis and the swivel axis. The third mower is located intermediate and behind the first and second mowers in the towing direction.

In further aspects of the present invention, a handheld remote control device actuates a control circuit of a control box for starting or stopping operation of a plurality of mowers.

In still further aspects of the present invention, a timer of a control circuit actuates a starter solenoid for a limited time for actuating a starter of an internal combustion engine. In preferred forms of the present invention, the control circuit includes another timer actuating a choke actuator for a limited time for actuating a choke of the internal combustion engine.

The present invention will become clearer in light of the following detailed description of an illustrative embodiment of this invention described in connection with the drawings.

### DESCRIPTION OF THE DRAWINGS

The illustrative embodiment may best be described by reference to the accompanying drawings where:

FIG. 1 shows a perspective view of a towable rotary mowing apparatus according to the preferred teachings of the present invention.

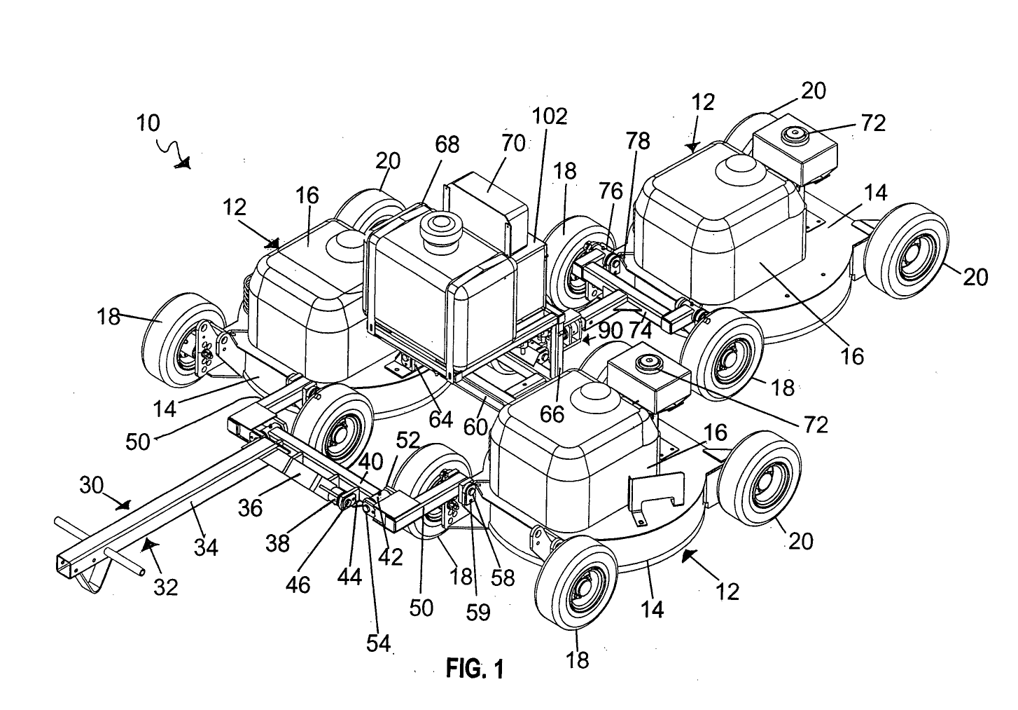

FIG. 2 shows an exploded, perspective view of the towable rotary mowing apparatus of FIG. 1, with portions being removed for ease of illustration.

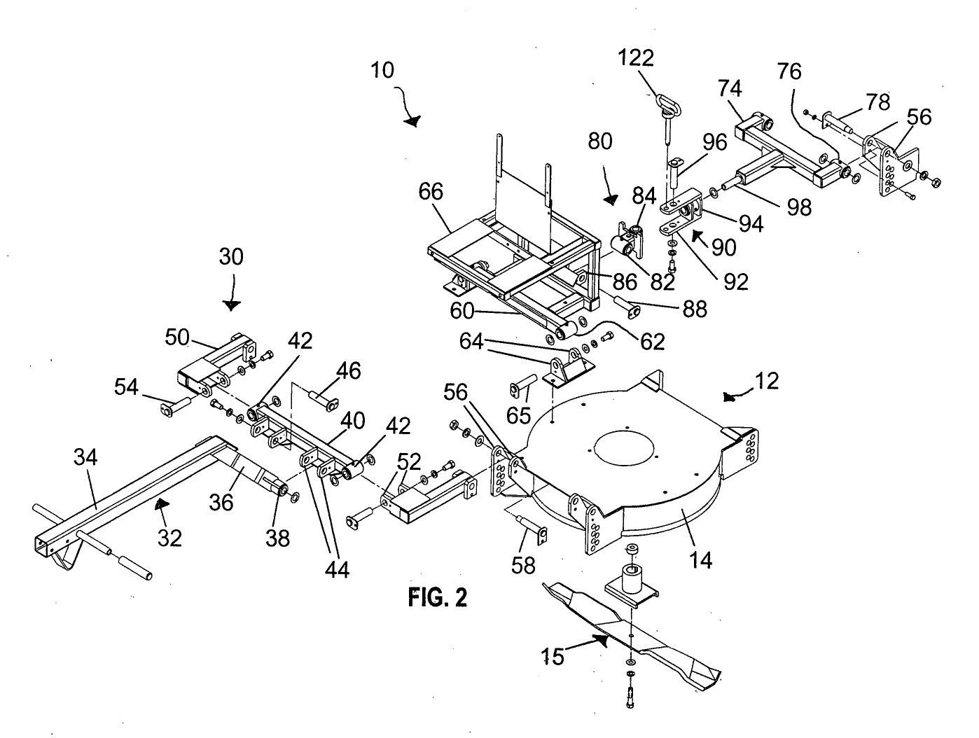

FIG. 3 shows a diagrammatic view of the control circuit for the towable rotary mowing apparatus of FIG. 1.

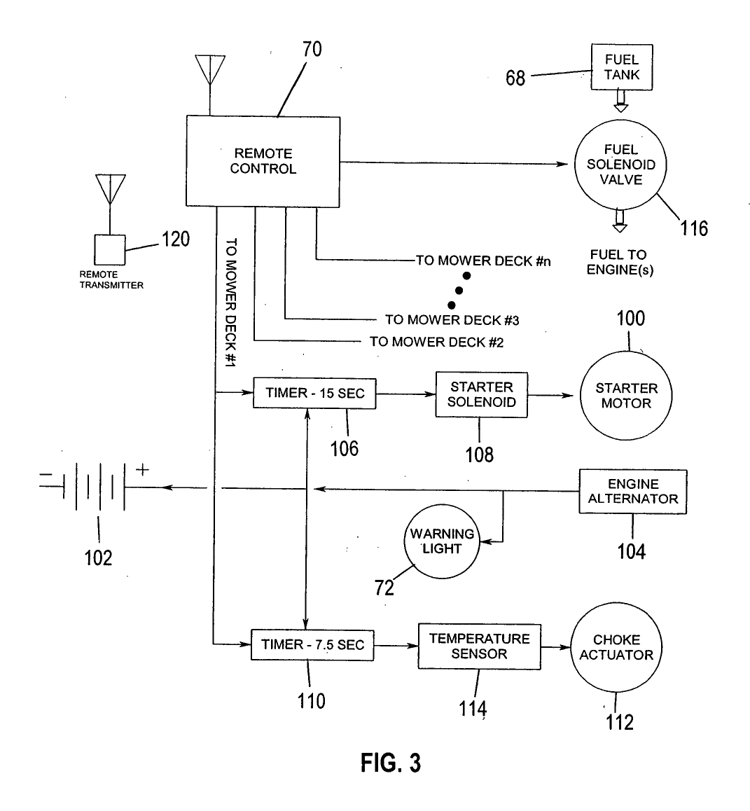

FIG. 4 shows a diagrammatic view of a pivotable movement restraint usable in the towable rotary mowing apparatus of FIG. 1 according to the preferred teachings of the present invention.

All figures are drawn for ease of explanation of the basic teachings of the present invention only; the extensions of the figures with respect to number, position, relationship, and dimensions of the parts to form the preferred embodiment will be explained or will be within the skill of the art after the following description has been read and understood. Further, the exact dimensions and dimensional proportions to conform to specific force, weight, strength, and similar requirements will likewise be within the skill of the art after the following description has been read and understood.

Where used in the various figures of the drawings, the same numerals designate the same or similar parts. Furthermore, when the terms “top”, “bottom”, “first”, “second”, “front”, “back”, “outer”, “inner”, “upper”, “lower”, “height”, “width”, “length”, “size”, “end”, “side”, “horizontal”, “vertical”, “axial”, “radial”, and similar terms are used herein, it should be understood that these terms have reference only to the structure shown in the drawings as it would appear to a person viewing the drawings and are utilized only to facilitate describing the illustrative embodiment.

### DESCRIPTION

A towable rotary mowing apparatus according to the preferred teachings of the present invention is shown in the drawings and generally designated 10. Generally, apparatus 10 includes a plurality of rotary mowers 12 each including a cylindrical deck 14 enclosing a rotatably mounted blade 15 rotatable about a vertical axis, with deck 14 being open on its lower end to allow blade 15 to rotate and cut the grass. Suitable provisions 16 such as an internal combustion engine are mounted to the deck 14 for rotating blade 15. It can be appreciated that other manners for rotating blade 15 can be utilized according to the teachings of the present invention including but not limited to electric or hydraulic motors or the like. Additionally, suitable provisions provide mobility of deck 14 relative to the lawn and allow deck 14 to follow the contour of the lawn and to cut the grass at a specified height. In the most preferred form, such provisions are in the form of a pair of front wheels 18 and a pair of rear wheels 20 mounted on opposite sides of the deck 14. In the most preferred form where wheels 18 and 20 provide mobility, the height of cut can be changed by raising or lowering the position of wheels 18 and/or 20 relative to deck 14. It can be appreciated that other manners for changing the cutting height can be utilized according to the teachings of the present invention. Further, other manners of providing mobility can be utilized according to the teachings of the present invention including but not limited to skids, rollers, tracks or the like which engage the lawn, the use of air pressure developed to levitate deck 14 over the lawn, or the like.

Apparatus 10 according to the teachings of the present invention includes a tow frame 30. Particularly, tow frame 30 includes a towing tongue 32 of a generally Y-shape including an elongated trunk 34 and first and second arms 36. In the most preferred form, arms 36 each terminate in collars 38 which are horizontally spaced from each other. In the most preferred form, arms 36 extend at an acute angle in the order of 45° in a vertical plane from the rear end of trunk 34. The front end of trunk 34 can be suitably removably connected to a towing vehicle using any suitable hitch device such as but not limited to a ball hitch on the towing vehicle and a coupler on trunk 34, with the hitch device in the preferred form allowing rotational movement about all three axes. When suitably connected, trunk 34 extends parallel to the towing direction, and collars 38 are aligned and extend generally perpendicular to the towing direction. The towing vehicle can be a tractor, ATV, utility cart, or any other suitable device.

Tow frame 30 further includes a front link 40 extending generally perpendicular to trunk 34 and the towing direction, with the opposite ends of front link 40 each terminating in collars 42 which are in a parallel, spaced relation to each other and which extend parallel to the towing direction. Suitable provisions are provided to pivotably mount front link 40 relative to towing tongue 32 about a front axis perpendicular to the towing direction and generally parallel to the lawn. In the most preferred form, front link 40 includes first and second pairs of ears 44 between which collars 38 are received, with pins 46 extending through ears 44 and collars 38 and defining the front axis.

Tow frame 30 further includes first and second side links 50 extending generally parallel to trunk 34 and the towing direction. Suitable provisions are provided to pivotably mount side links 50 to the opposite ends of front link 40 about side axes spaced and parallel to each other and parallel to trunk 34 and the towing direction. In the most preferred form, each side link 50 includes a pair of ears 52 adjacent its leading end between which an assorted collar 42 is received, with a pin 54 extending through ears 52 and collar 42 and defining the side axis. The trailing end of each side link 50 is suitably secured to a forward, inside corner of one of a pair of leading rotary mowers 12. In the most preferred form, a pair of ears 56 are formed with the mounting brackets for front wheels 18 and between which the trailing end of an associated side link 50 is received, with a pin 58 extending through ears 56 and side link 50. In the preferred form, a pin 59 extends parallel to and spaced from pin 58 through aligned holes formed in a head for pin 58, ears 56, and tabs formed on the trailing end of side link 50 to prevent relative pivotal movement of side link 50 and the first and second mowers 12. In the preferred form, a line extending through pins 58 for both rotary mowers 12 connected by side links 50 is linearly straight.

Tow frame 30 further includes a mid link 60 extending generally perpendicular to trunk 34 and the towing direction, with the opposite ends of mid links 60 each terminating in collars 62 which are in a parallel, spaced relation to each other and which extend parallel to the towing direction. Suitable provisions are provided to pivotably mount mid link 60 to the leading rotary mowers 12 about the side axes. In the most preferred form, each of the leading rotary mowers 12 include a pair of ears 64 suitably secured to deck 14 intermediate front and rear wheels 18 and 20 and adjacent to its inner periphery. A pin 65 extends through ears 64 and collars 62 and defines the side axis. It should be appreciated that pins 54 and 65 are along common side axes to allow maximum roll freedom of first and second mowers 12. If either pair of pivot pins 54 and 65 is not on a common axis, the roll motion of the corresponding mower 12 will be restricted, and unnecessary loads will be transmitted to the mid link 60 and/or towing tongue 32 and/or front link 40 when apparatus 10 travels over undulating surfaces.

In the most preferred form, mid link 60 includes a carrier 66 for a fuel tank 68 and for a control box 70 for internal combustion engines 16. It should be appreciated that carrier 66 provides a stable platform to carry common components of mowers 12, with the weight of fuel tank 68, control box 70, a battery 102 and other components carried thereby being evenly distributed to the turf by the inner wheels 18 and 20 of the first and second mowers 12. Mounting these common components on towing tongue 32 would cause the front, inside wheels 18 of first and second mowers 12 to be more heavily loaded, causing possible damage to the grass or surface being traversed and would prevent towing tongue 32 from being rotated to a generally upward position for saving space during storage, trailer transport, etc. Further, only the addition of costly pivoting trays on towing tongue 32 would allow battery 102 and fuel tank 68 to maintain their necessary, level relationship to the ground. Distributing these components onto several mowers 12 would increase the complexity and cost of the mower assembly.

Tow frame 30 further includes a rear link 74 extending generally perpendicular to trunk 34 and the towing direction. In the most preferred form, rear link 74 is generally U-shaped having legs which terminate in collars 76 which are horizontally spaced from each other. Rear link 74 is pivotably mounted to a trailing rotary mower 12 about a rear axis spaced and parallel to the front axis and generally perpendicular to the towing direction, trunk 34 and the side axes. In the most preferred form, pins 78 extend through ears 56 for the pair of front wheels 18 and the associated collar 76 to define the rear axis.

Suitable provisions are provided to pivotably mount rear link 74 about three perpendicular axes relative to mid link 60. In the most preferred form, tow frame 30 includes a pivot link 80 including first and second collars 82 and 84 extending generally perpendicular to each other. Pivot link 80 is suitably pivotably mounted to mid link 60 (in the preferred form through carrier 66) about a mid axis parallel to and spaced intermediate the front and rear axes and generally perpendicular to the towing direction, trunk 34 and the side axes. In the most preferred form, a pair of ears 86 extend from carrier 66 and between which collar 82 is received, with a pin 88 extending through ears 86 and collar 82 and defining the mid axis.

Tow frame 30 further includes a swivel 90 in the preferred form of a U-shape and including a pair of ears 92 extending from an interconnection 94. Swivel 90 is suitably pivotably mounted to pivot link 80 about a pivot axis. In the most preferred form, a pin 96 extends through ears 92 and collar 84 and defines the pivot axis. Swivel 90 is suitably pivotably mounted to rear link 74 about a swivel axis perpendicular to the pivot axis. In the most preferred form, a pin 98 extends from rear link 74 and through interconnection 94 and defines the swivel axis. It should be appreciated that the pivot axis extends in a plane generally perpendicular to the lawn.

According to the preferred teachings of the present invention, fuel tank 68 provides fuel to each rotary mower 12. This feature is believed to be advantageous as it is only necessary to fill one tank 68 as opposed to multiple tanks and fuel can be stopped to all mowers 12 at a single location. However, it can be appreciated that each individual mower 12 could include its own supply independent of the others. Likewise, although fuel tank 68 is mounted to towing frame 30 to be included with apparatus 10, fuel tank 68 could be mounted to the towing vehicle. Furthermore, although internal combustion engines 16 are shown in the preferred form, batteries or similar electrical supply could be carried by tow frame 30 and/or carried by or provided by the towing vehicle when electrical motors are utilized in mowers 12, a hydraulic pump or similar hydraulic supply could be carried by tow frame 30 and/or carried by or provided by the towing vehicle when hydraulic motors are utilized in mowers 12, or the like.

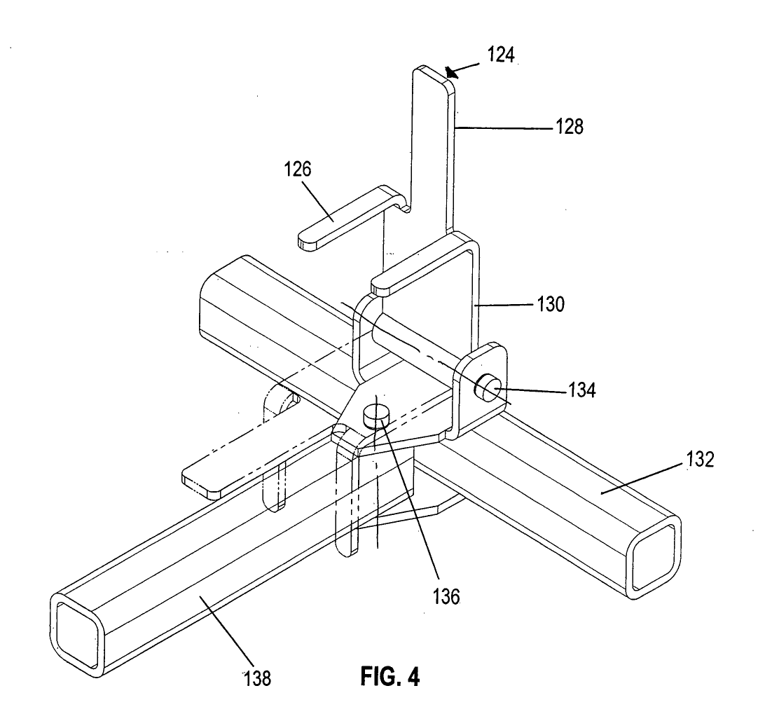

The towing direction of forward travel can be considered generally in the x-direction when towing tongue 32 is being towed by the towing vehicle. Mowers 12 are allowed to rotate in three axes (pitch, roll, yaw) to facilitate even cutting height over undulating terrain. However, to facilitate straight line tracking when traversing hillsides, when backing up apparatus 10 as might occur when loading/unloading apparatus 10 from a trailer or when moving to/from storage such as in a garage, or the like, mowers 12 can be physically restrained from movement about one or more of the three axes. In a preferred form, a locking pin or rod 122 can be inserted through holes in ears 92 and pivot link 80 which will prevent rotation about the pivot axis defined by pin 96. Rotation about other axes of each mower 12 can be prevented by adding similar restraints. Insertion of pin 122 requires alignment so that pin 122 can be inserted into corresponding holes, which is often difficult to do due to the weight and/or due to the position of the mower 12 attached to the pivotable connection. Similarly, removal of pin 122 can be difficult if the pivotable connection is loaded in a direction that puts pressure on pin 122. Thus, restraints which do not require the pivotable connection to be aligned and/or which is easier to remove if loaded can be provided. As an example, a fork 124 can be rotated between a restrained position and a released position. In particular, in the preferred form shown, fork 124 is generally T-shaped including first and second legs 126 extending intermediate a handle portion 128 and a connection portion 130. The free end of connection portion 130 is pivotably connected to a first component 132 of the pivotable connection such as by a pin 134 extending through ears of the pivot bracket of the pivotable connection. The fork axis is perpendicular to the pivot axis defined by a pin 136 between the first component 132 and the second component 138 of the pivotable connection. In a lowered position as shown in phantom in FIG. 4, connection portion 130 extends over pin 136, and legs 126 are located on opposite sides of component 138 to prevent relative pivotable movement of components 132 and 138 about pin 136. In a raised position as shown in solid in FIG. 4, components 132 and 138 are free to pivot about pin 136. If the pivotable connection is not properly aligned to allow fork 124 to move into its lowered position, pulling apparatus 10 straight ahead will cause fork 124 to align with component 138 and drop into its restrained position. Fork 124 can be held in the restrained or released positions by the application of springs, magnetic latches, or other devices.

In the most preferred form, a secondary control box of each mower 12 includes an indicator 72 for indicating that blade 15 of mower 12 is being rotated. In the preferred form, indicator 72 is in the form of a light which illuminates when mower 12 is operating and is located at an elevated position on mower 12 to make it visible over other components of apparatus 10. Such indicator 72 allows the operator or others around apparatus 10 to realize that one or more of mowers 12 are operating, as several mowers 12 operating at one time might make it difficult to determine from sound alone which mowers 12 are running or stopped.

A common approach for starting mowers 12 utilizing internal combustion engines 16 is a pull rope starter (recoil starters). It can be appreciated that starting utilizing such pull ropes is time consuming and is multiplied by the number of mowers 12 utilized in apparatus 10. Further, the operator is closely adjacent mower 12 when starting utilizing such pull ropes which puts the operator in danger such as if the operator's feet slide under deck 14, if mower 12 rolls over the operator's feet, if mower 12 throws objects from under deck 14, and the like. According to the preferred teachings of the present invention, each individual mower 12 can be started and/or stopped remotely. This allows the operator to remain safely seated on the towing vehicle and limits exposure of the operator to potential damages such as objects thrown by mowers 12. Additionally, the operator can easily stop and/or restart mowers 12 when transporting apparatus 10 over areas not intended to have grass cut or over areas which are non turf such as but not limited to paving and when pedestrians or other onlookers may come within an unsafe distance of the mowers 12.

Particularly, in the preferred form where mowers 12 are powered by internal combustion engines 16, such engines 16 include starter motors 100. Starter motors 100 in the preferred form are battery powered, and as such battery 102 is provided. Battery 102 can be carried by carrier 66 or otherwise included in apparatus 10 or can be carried by the towing vehicle. Alternatively, electrical power to the starter motors 100 could be provided by the towing vehicle or from other sources. When apparatus 10 is self contained, one or more internal combustion engine 16 may include a generator 104 to recharge battery 102 and/or to power indicators 72 and/or other electrical devices such as lights, cooling fans, etc. such as but not limited to such devices located inside or carried by control box 70.

Control box 70 includes a control circuit for starting a first timer 106 controlling a starter solenoid 108 in turn controlling starter motor 100. As there are engine manufacturer recommended time limits (such as 15 seconds) to avoid overheating and/or burnout of starter motor 100, timer 106 activates starter solenoid 108 and thus starter motor 100 for a limited time.

The control circuit of control box 70 also starts a second timer 110 controlling a choke actuator 112 in turn controlling a choke of the internal combustion engine 16. Choke actuator 112 can be a linear or rotary solenoid or any other device capable of providing motion needed to engage the choke of the internal combustion engine 16. Choke actuator 112 can be connected directly to the choke or work through a lever mechanism, push-pull cable, or the like. In the most preferred form, a temperature sensor switch 114 blocks actuation of choke actuator 112 by timer 110 if internal combustion engine 16 is warm. Applying the choke to internal combustion engine 16 when warm may cause flooding and prevent internal combustion engine 16 from starting. In the preferred form where generators 104 are provided to each internal combustion engine 16, the electrical energy produced by generator 104 when engine 16 is running can be sensed and used to turn off timers 106 and 110.

According to the preferred teachings of the present invention, the control circuit of control box 70 also controls a fuel solenoid valve 116 for fuel tank 68. During transport especially over turf or other unpaved areas, the vibration amplitude and frequency on engines 16 is much higher than typically occurs on a walk behind or a conventional rider mower. This is due to the higher travel speeds. It has been found that the carburetors on these engines 16 cannot stop the flow of fuel when subjected to this vibration. Therefore, the addition of fuel solenoid valve 116 to shut off the fuel supply during transport will prevent engine flooding due to excess fuel, fuel leaking from carburetors, etc. It should be appreciated that although in the preferred form only one fuel solenoid valve 116 is utilized, individual solenoid valves 116 could be utilized in fuel lines to engine 16 from a common fuel tank 68 or from individual fuel tanks according to the teachings of the present invention.

The control circuit of control box 70 according to the teachings of the present invention is capable of stopping engines either by shorting the engine ignition coil using the wiring (i.e., single lead ground wire) normally provided for such purposes by the engine manufacturer, or by stopping the flow of fuel utilizing fuel solenoid valve 116. The former method is preferred, as it stops engine 16 without the need to burn fuel already in the carburetor fuel bowl and fuel lines. However, the latter can be used as a secondary manner if electrical problems occur.

Apparatus 10 according to the preferred teachings of the present invention includes a handheld remote control device 120 used to signal the control circuit of control box 70 that one or more of the mower engines 16 should start/stop. In the most preferred form, a remote, radio frequency control device 120 is used to perform this remote start/stop function. However, infrared, sound, or even a wired pendant could be used to accomplish the function according to the teachings of the present invention.

Apparatus 10 according to the teachings of the present invention may include additional features for the safety and convenience of the operator as well as persons nearby. Specifically, an emergency stop switch(es) can be provided so that the operator can quickly stop all engines 16 in an emergency situation. A key switch can be provided to control the control circuit of control box 70. This switch can serve as a lockout during maintenance periods or whenever accidental or unintentional starting of mowers 12 is a concern. An hour meter displaying the cumulative operating time of the mowers 12 can be provided as an aide to performing scheduled maintenance and for warranty purposes. A manual starting over ride circuit can be provided to allow the engines 16 to be started with the pull rope (recoil) starter in the event that the battery 102 becomes discharged or in the event that a battery 102 is not available. The over ride circuit also powers the fuel solenoid 116 when an engine 16 is running. The handheld remote control device 120 may contain sufficient signal channels to start each engine 16 singly or in a timed sequential manner. Starting all engines 16 simultaneously may require battery(ies) 102 and/or other electrical components with higher than normal current carrying capacities. The handheld control device 120 should include a signal to simultaneously stop all engines 16. Other signal channels may include operator controlled actuation of choke actuator 112 and/or of fuel solenoid valve 116. A sleep mode can be provided to shut down the control circuit of control box 70 if the circuit is left on for a specified period of time without the engines 16 running. Cycling the key switch is one manner of turning off exiting the sleep mode.

Now that the basic teachings of the present invention have been explained, many extensions and variations will be obvious to one having ordinary skill in the art. For example, although apparatus 10 of the preferred form includes a combination of several features which is believed to produce synergistic results, such features could be utilized singly and/or in different combinations. As an example, the control circuit according to the teachings of the present invention could be utilized with other types of mowers, with other types of ganging constructions, with individual mowers, or the like. Likewise, tow frame 30 according to the teachings of the present invention could be utilized without control circuit and/or with control circuits of different types and designs.

Additionally, although various forms of pivotable connections between tow frame 30 and mowers 12 of the preferred form have been shown and described, other manners and forms of pivotable connections can be utilized according to the preferred teachings of the present invention. It can be appreciated that the construction of tow frame 30 and in particular mid and rear links 60 and 74 could change drastically if other manners and forms of pivotable connections were utilized. For example, the pivotable connections utilized for the third mower 12 could be utilized to connect the first and second mowers 12 to front link 40 and/or towing tongue 32.

Further, although shown in the preferred form as including three mowers 12, tow frame 30 could be created according to the teachings of the present invention utilizing a different number of mowers 12. As an example, two additional mowers 12 could be placed on opposite sides of the third mower 12 by repeating the rear link 74 and pivotable connections to the outer rear corners of the first and second mowers 12.

Furthermore, one or more mowers 12 could be outfitted with a suitable handle which will allow the mower 12 to be converted into a traditional walk-behind mower. This will be useful when traveling to an area in which operation of apparatus 10 is not possible due to close proximity of trees, intricate cutting paths, narrow strips of turf, etc. To use this way, the mower 12 is detached from the towing frame 30, and possibly a handle can be moved from a storage position to its working position. The process is reversed to return mower 12 into apparatus 10 according to the teachings of the present invention.

Those skilled in the art will further appreciate that the present invention may be embodied in other specific forms without departing from the spirit or central attributes thereof. In that the foregoing description of the present invention discloses only exemplary embodiments thereof, it is to be understood that other variations are contemplated as being within the scope of the present invention. Accordingly, the present invention is not limited in the particular embodiments which have been described in detail therein. Rather, reference should be made to the appended claims as indicative of the scope and content of the present invention.

1. Mowing apparatus comprising, in combination: first, second, and third mowers; and a tow frame for ganging the mowers, with the tow frame including a towing tongue adapted to be removably connected to a towing vehicle for being towed in a towing direction, with the first and second mowers being pivotably connected to the towing tongue about a front axis, with the front axis being generally perpendicular to the towing direction, with the first mower being pivotably connected to the towing tongue about a first side axis parallel to and spaced from the towing direction and the second mower being pivotably connected to the towing tongue about a second side axis parallel to and spaced from the towing direction and to the first side axis, with the third mower being pivotably connected relative to the first and second mowers about a mid axis, a swivel axis perpendicular to the mid axis, and a pivot axis perpendicular to the mid axis and the swivel axis, with the third mower located intermediate and behind the first and second mowers in the towing direction.

2. The mowing apparatus of claim 1 with the tow frame including a mid link having first and second ends, with the first end of the mid link pivotably mounted to the first mower about the first side axis, with the second end of the mid link pivotably mounted to the second mower about the second side axis, with the third mower being pivotably connected to the mid link.

3. The mowing apparatus of claim 2 with the third mower further being pivotably connected relative to first and second mowers about a rear axis, with the rear axis being parallel to and spaced from the mid axis.

4. The mowing apparatus of claim 3 with the tow frame including a rear link, with the third mower being pivotably connected to the rear link about the rear axis, with the mid link pivotably connected to the rear link about the mid, swivel, and pivot axes.

5. The mowing apparatus of claim 4 with the tow frame including a pivot link including a first collar and a second collar extending perpendicular to the first axis, with the first collar defining the mid axis and the second collar defining the pivot axis.

6. The mowing apparatus of claim 5 with the tow frame including a swivel having a U-shape including a pair of ears extending from an interconnection and a pin extending through the pair of ears and the second collar and defining the pivot axis, with the rear link including a pin extending through the interconnection and defining the swivel axis.

7. The mowing apparatus of claim 6 with the mid link including a pair of ears, with the tow frame further including a pin extending through the pair of ears of the mid link and the first collar and defining the mid axis.

8. The mowing apparatus of claim 7 with the rear link being of a generally U-shape and having first and second legs terminating in collars which are aligned and spaced from each other, with the collars of the rear link defining the rear axis.

9. The mowing apparatus of claim 8 with the mowers each including a pair of front wheels mounted by mounting brackets, with the tow frame further including first and second pins extending through the mounting brackets and the collars of the rear link and defining the rear axis.

10. The mowing apparatus of claim 9 with the mowers being rotary mowers and each including a blade rotatable about a vertical axis, with the mowers each including a pair of rear wheels.

11. The mower apparatus of claim 4 with the tow frame including a front link, with the front link being pivotally mounted to the towing tongue by the front axis, with the first and second mowers being pivotally connected to the front axis, with the first and second mowers being pivotally connected to the front link by the first and second side axes.

12. The mower apparatus of claim 11 with the tow frame including first and second side links, with the first link being pivotally mounted to the front link by the first side axis, with the second link being pivotally mounted to the front link by the second side axis.

13. The mower apparatus of claim 12 with the front link terminating in first and second collars, with each of the first and second side links including a pair of ears and a pin extending through the pair of ears and the collar of the first link and defining the side axis.

14. The mowing apparatus of claim 13 with the mowers each including a pair of front wheels mounted by mounting brackets, with the tow frame further including first and second pins extending through the mounting brackets and trailing ends of the first and second side links.

15. The mower apparatus of claim 6 with the tow frame including means for selectively physically restraining pivotable movement about the pivot axis.

16. The mower apparatus of claim 2 with the mid link including a carrier adapted to carry common components of the first, second and third mowers.

17. The mowing apparatus of claim 1 with each of the first, second and third mowers including an indicator for indicating that the mower is operating.

18. The mowing apparatus of claim 1 further comprising, in combination: a control box including a control circuit for starting or stopping operation of the first, second and third mowers; and a handheld remote control device actuating the control circuit of the control box.

19. The mowing apparatus of claim 17 with each of the first, second, and third mowers including internal combustion engines including a starter, with the control circuit including a timer actuating a starter solenoid for actuating for a limited time the starters of the internal combustion engines.

20. The mowing apparatus of claim 19 with the internal combustion engines further including a choke, with the control circuit including a timer actuating for a limited time a choke actuator actuating the choke, with the control circuit including a temperature sensor for blocking actuation of the choke actuator when the internal combustion engine is warm.

21. The mowing apparatus of claim 20 further comprising, in combination: a fuel tank for the internal combustion engines, with the control circuit further including a fuel solenoid valve for controlling fuel flow to the internal combustion engines.

22. Mowing apparatus comprising, in combination: first, second, and third mowers; a tow frame for ganging the mowers, with the tow frame adapted to be removably connected to a towing vehicle for being towed in a towing direction; a control box including a control circuit for starting or stopping operation of the first, second and third mowers; and a handheld remote control device actuating the control circuit of the control box.

23. Control circuit for an internal combustion engine including a starter, with the control circuit including a timer actuating a starter solenoid for actuating for a limited time the starter of the internal combustion engine.
